(19) United States
(12) Patent Application Publication
(10) Pub. No.: US 2016/0298833 A1
(43) Pub. Date: Oct. 13, 2016

(54) LIGHT-EMITTING DEVICE OF 3D PRINTING LAMP AND SUPPLY SYSTEM ON 3D PRINTING LAMP LINE USING THE LIGHT-EMITTING DEVICE

(71) Applicant: JIA-HORNG LIN, Taoyuan City (TW)

(72) Inventor: JIA-HORNG LIN, Taoyuan City (TW)

(21) Appl. No.: 14/864,484

(22) Filed: Sep. 24, 2015

(30) Foreign Application Priority Data
Apr. 10, 2015 (TW) 104111641

(51) Int. Cl. F21V 23/06; G05B 19/4099; B29C 67/00; F21V 23/00; F21V 23/04

(52) U.S. Cl. CPC F21V 23/06; F21V 23/002; F21V 23/04; B29C 67/0088; G05B 19/4099; G05B 2219/35134; G05B 2219/49007; B33Y 50/02

(57) ABSTRACT

A light-emitting device of a 3D printing lamp, which is disposed in a light bulb for use in 3D printing, includes an adapter, connection unit, carrying unit, transparent cover and power line. The connection unit is disposed on the adapter. The connection unit has a limiting opening. The carrying unit has a connector and thus is rotatably disposed in the limiting opening. The carrying unit has therein a receiving space for receiving at least a light-emitting diode module. The transparent cover is disposed on the carrying unit to hermetically seal the receiving space. The power line is connected to the adapter. The light-emitting device is conveniently mounted on the light bulb to easily form a 3D printing lamp and rotatably adjust the light emission angle and thus appropriately define the shapes of the light bulb for use in 3D printing and patterns thereon, so as to meet user needs.

### CROSS-REFERENCE TO RELATED APPLICATION

This non-provisional application claims priority under 35 U.S.C. §119(a) on Patent Application No(s).104111641 filed in Taiwan, R.O.C. on Apr. 10, 2015, the entire contents of which are hereby incorporated by reference.

### FIELD OF THE INVENTION

The present invention relates to light-emitting devices and, more particularly, to a light-emitting device coupled to a light bulb for use in 3D printing to thereby form a 3D printing lamp and to a supply system on a 3D printing lamp line using the light-emitting device.

### BACKGROUND OF THE INVENTION

Product manufacturing processes nowadays entail plant-based design, die manufacturing, mass production, marketing by brick-and-mortar stores and online retailers, and delivery to consumers. To cut manufacturing costs, the products are of the shapes and specifications and produced massively. To enhance delivery safety, the products are packaged, thereby causing a waste of resources.

With 3D printing technology becoming popular, the process flow of product production and delivery to consumers changes in the manner that manufacturers and designers no longer need to make dies, build production lines and undertake mass production with a view to ensuring that the final products can have different shapes and specifications; instead, electronic files for use in manufacturing the intended products are created by 3D software and then sent to a user through the Internet.

The technology of 3D printing of lamps involves designing the shapes of a light bulb of a lamp by 3D software and creating a model, and then sending electronic files of the model to the user, such that the user selects and downloads the 3D model electronic files of the light bulb through the Internet, and then prints the required products with a 3D printing device, thereby saving the costs otherwise incurred in product packaging and delivery.

Although the users can conveniently obtain a light bulb by 3D printing technology, the users have to mount a light-emitting component, build related circuits, and install accessories on their own; and, doing so is rather difficult to average users. Furthermore, in a conventional lamp (non-3D printing lamp), its circuit structure and two-segment connection structure are complicated and difficult to remove, and thus the users cannot remove a light-emitting component from the conventional lamp in order to mount it on a 3D lamp. Hence, the application of 3D printing technology to lamp products still has room for improvement.

### SUMMARY OF THE INVENTION

It is an objective of the present invention to provide a light-emitting device which can be conveniently mounted on a light bulb for use in 3D printing so that the light bulb is easy to change, so as to obtain 3D printing lamps of different shapes.

In order to achieve the above and other objectives, the present invention provides a light-emitting device of a 3D printing lamp, which is disposed in a light bulb for use in 3D printing. The light-emitting device comprises an adapter, a connection unit, a carrying unit, a transparent cover and a power line. The connection unit is disposed on the adapter. The connection unit has a limiting opening. The carrying unit has a connector so as to be rotatably disposed in the limiting opening. The carrying unit has therein a receiving space for receiving at least a light-emitting diode module. The transparent cover is disposed on the carrying unit to hermetically seal the receiving space. The power line is connected to the adapter.

Regarding the light-emitting device, the connection unit has a casing body, a limiting plate and a spring. The casing body has an end provided with the limiting opening and another end connected to the adapter. The limiting opening has two limiting recesses opposing each other. The connector has two curved bulging portions corresponding in position to the two limiting recesses. The limiting plate has a surface in contact with the two curved bulging portions. The spring is disposed in the casing body and compressed enough to abut against the limiting plate and the adapter.

The light-emitting device further comprises a base connected to the adapter and adapted to underpin the light bulb.

Regarding the light-emitting device, a plug of the power line is a USB port.

Regarding the light-emitting device, the power line has a power switch for controlling the at least a light-emitting diode to turn on or turn off.

In order to achieve the above and other objectives, the present invention further provides a supply system on a 3D printing lamp line so as to be connected to an electronic device of a user and provide light bulb model files for use with the light-emitting device. The supply system comprises a network-based communication component and a server host. The network-based communication component is connected to a network. The server host is connected to the network-based communication component, such that the electronic device of the user gets connected to the server host through the network. The server host comprises a 3D model database. The 3D model database stores light bulb model files for use with the 3D printing device, such that the 3D printing device prints a light bulb according to the light bulb model files. The light bulb is coupled to the light-emitting device to thereby form the 3D printing lamp.

In conclusion, the light-emitting device of the 3D printing lamp can be conveniently coupled to a light bulb for use in a 3D printing light bulb to thereby easily form a 3D printing lamp, such that the light-emitting device can rotatably adjust a light emission angle and appropriately define the shapes of the light bulb for use in 3D printing light bulb and patterns thereon, so as to meet the user needs.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of a light-emitting device and a light bulb according to an embodiment of the present invention;

FIG. 2 is an exploded view of the light-emitting device according to an embodiment of the present invention;

FIG. 3 is a schematic enlarged view of a connection unit according to an embodiment of the present invention;

FIG. 4 is a schematic view of the light-emitting device according to an embodiment of the present invention;

FIG. 5 is a schematic view of a base of the light-emitting device according to another embodiment of the present invention;

FIG. 6 is a schematic view of the base of the light-emitting device according to yet another embodiment of the present invention; and

FIG. 7 is a block diagram of a supply system on a 3D printing lamp line according to an embodiment of the present invention.

### DETAILED DESCRIPTION OF THE PREFERRED EMBODIMENTS

In an embodiment of the present invention, a light-emitting device is disposed in a light bulb for use in 3D printing to form a 3D printing lamp. Light emitted from the light-emitting device falls on the patterns shown on the light bulb for use in 3D printing light bulb or highlight the appearance of the light bulb for use in 3D printing light bulb to therefore bring a special visual effect.

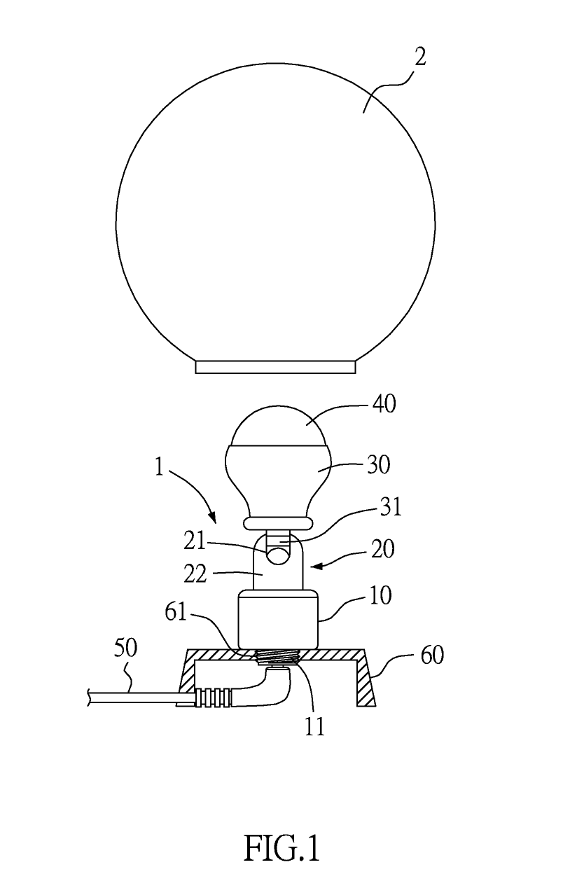

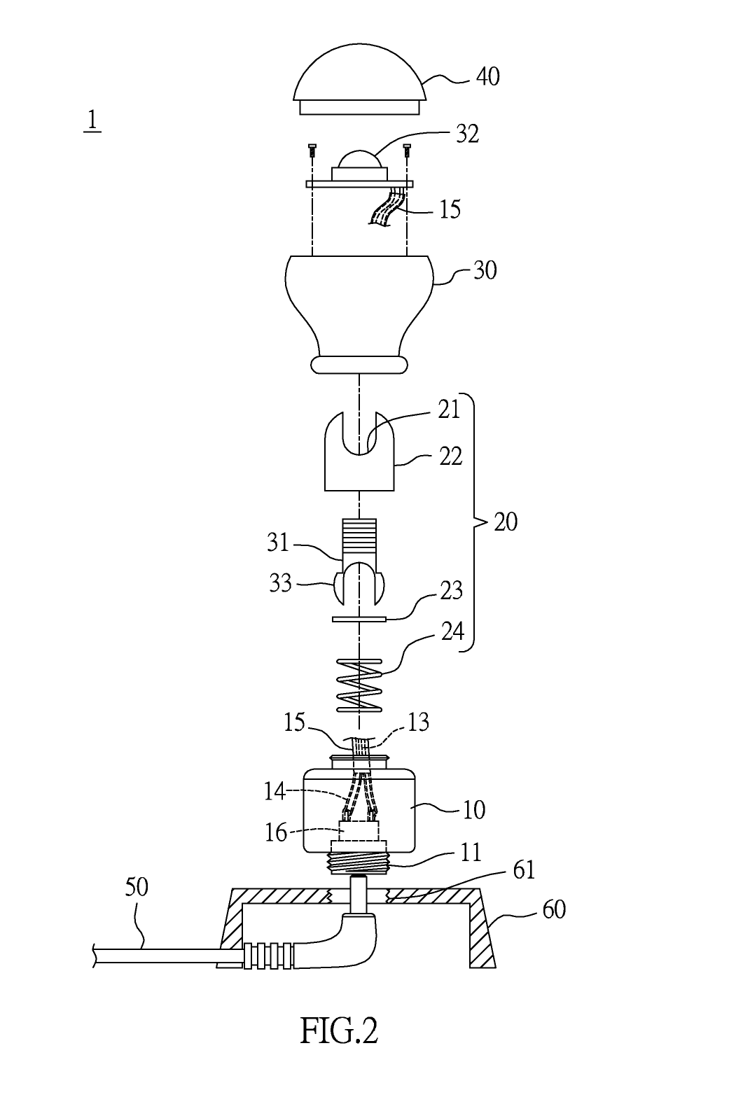

Referring to FIG. 1 through FIG. 3, in an embodiment of the present invention, the light-emitting device 1 is disposed in the light bulb for use in 3D printing 2, and the light-emitting device 1 comprises an adapter 10, a connection unit 20, a carrying unit 30, a transparent cover 40 and a power line 50. The adapter 10 is, for an illustrative purpose, cylindrical and penetrated by a channel. The connection unit 20 is disposed on the adapter 10. The connection unit 20 has a limiting opening 21. The carrying unit 30 has a connector 31 rotatably disposed in the limiting opening 21. The carrying unit 30 has therein a receiving space for receiving at least a light-emitting diode module 32. The transparent cover 40 is disposed on the carrying unit 30 to hermetically seal the receiving space. The power line 50 is connected to the adapter 10.

Therefore, in this embodiment, the light-emitting device 1 has the carrying unit 30 which can be rotated relative to the connection unit 20 to thereby adjust the direction in which the at least a light-emitting diode module 32 emits light, according to the shape of a light bulb 2, patterns on the light bulb 2 or user needs.

The connection unit 20 has a casing body 22, a limiting plate 23 and a spring 24. The casing body 22 has an end provided with the limiting opening 21 and another end connected to the adapter 10. The limiting opening 21 has two limiting recesses 25 which oppose each other. The connector 31 has two curved bulging portions 33 corresponding in position to the two limiting recesses 25. The limiting plate 23 has a surface in contact with the two curved bulging portions 25. The spring 24 is disposed in the casing body 22 and compressed enough to abut against the limiting plate 23 and the adapter 10. Hence, with the two curved bulging portions 23 being stopped by the two limiting recesses 25 and the spring 24 abutting against the limiting plate 23, the connector 31 can be confined to the limiting opening 21 and rotates relative thereto.

The limiting plate 23 has a central through hole. The central through hole of the limiting plate 23 and a hole defined by the spring 24 together form a channel.

The adapter 10 has therein a terminal 16. The power line 50 is plugged into the terminal 16. The terminal 16 is connected to the light-emitting diode module 32 by two wires 13. The two wires 13 are connected to the light-emitting diode module 32 through the spring 24, the limiting plate 23 and the connector 31. The junction of each of the two wires and the terminal is enclosed by a heat-shrink tubing 14. The heat-shrink tubing 14 is resistant to heat, insulating, and highly elastic so as to ensure that the two wires 13 can maintain satisfactory electrical connection with the terminal 16. In addition, the two wires 13 can be further enclosed by a wire sheath 15.

Referring to FIG. 1, in this embodiment, the light-emitting device 1 further comprises a base 60 coupled to the adapter 10 and adapted to underpin the light bulb 2, such that the light-emitting device 1 is coupled to the light bulb 2. The base 60 corresponds in outline to the light bulb 2 such that the two are coupled together snugly or by a means of engagement. In this embodiment, the light-emitting device 1 can also be directly coupled to the light bulb 2 through the adapter 10, and the light bulb 2 has a mounting opening whereby the adapter 10 is fixed to the light bulb 2 by a thread or a means of engagement.

In addition, a mounting hole 61 is disposed on the top surface of the base 60. The mounting hole 61 has an internal thread. A post 11 is disposed at the bottom of the adapter 10, and the lateral surface of the post 11 has an external thread, such that the adapter 10 is mounted on the base 60 and coupled to the light bulb 2 through the base 60.

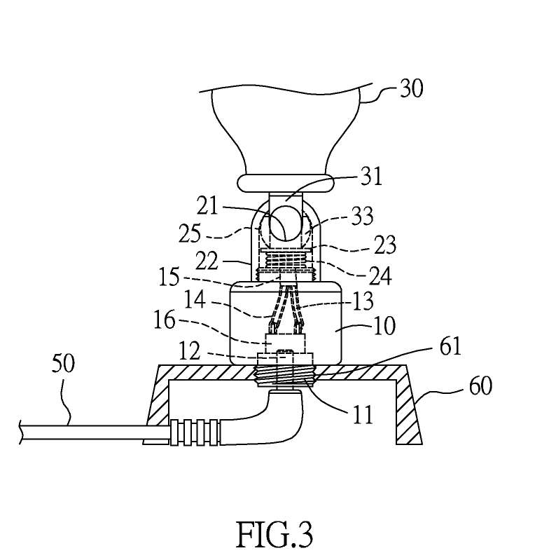

Referring to FIG. 3, the power line 50 has an end which can be plugged into a jack 12 of the adapter 10 through a DC connector, such that the power line 50 is electrically connected to a terminal 16 of the adapter 10. In addition, the DC connector at the end of the power line 50 is fixed to a stand of the light bulb 2, such that the light-emitting device 1 is coupled to the light bulb 2 as soon as the power line 50 is plugged into the jack 12 of the adapter 10.

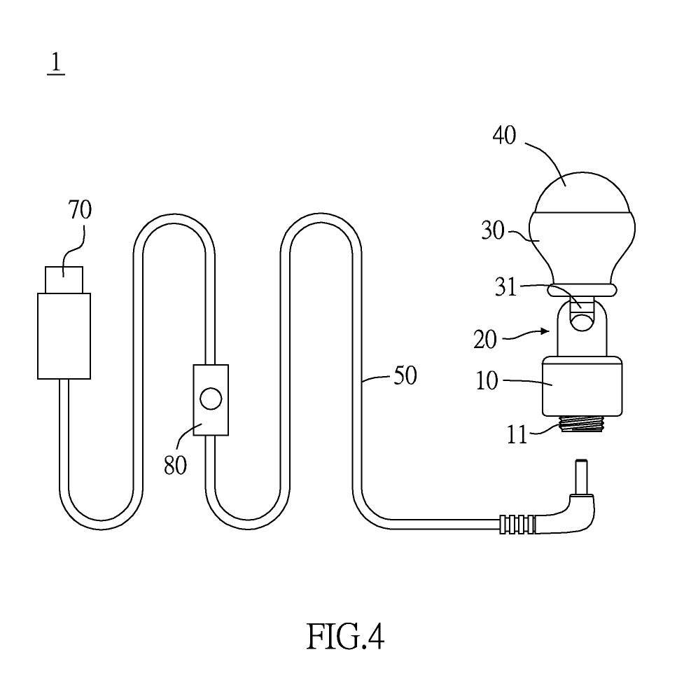

Referring to FIG. 4, the power line 50 has another end provided with a plug 70 so as to be electrically connected to a power source. The plug has a USB port and thus is connectable to a USB jack of a powered cellular phone charger, computer host, or notebook computer, such that electrical power can be supplied to the light-emitting device 1.

In addition, the power line 50 has a power switch 80 for controlling the at least a light-emitting diode 32 to turn on or turn off.

Referring to FIG. 1, FIG. 3 and FIG. 4, in this embodiment, wiring connection and circuit layout is integrated into the adapter 10, and the adapter 10 is mounted on the base 60 through the external thread of the post 11. The connection unit 20, the carrying unit 30 and the transparent cover 40 are positioned on one side of the adapter 10. The DC connector at the end of the power line 50 is plugged into the jack 12 of the adapter 10 through the mounting hole 61 of the base 60. Hence, compared with the prior art, this embodiment of the present invention provides a light-emitting device 1 which is convenient and friendly to users.

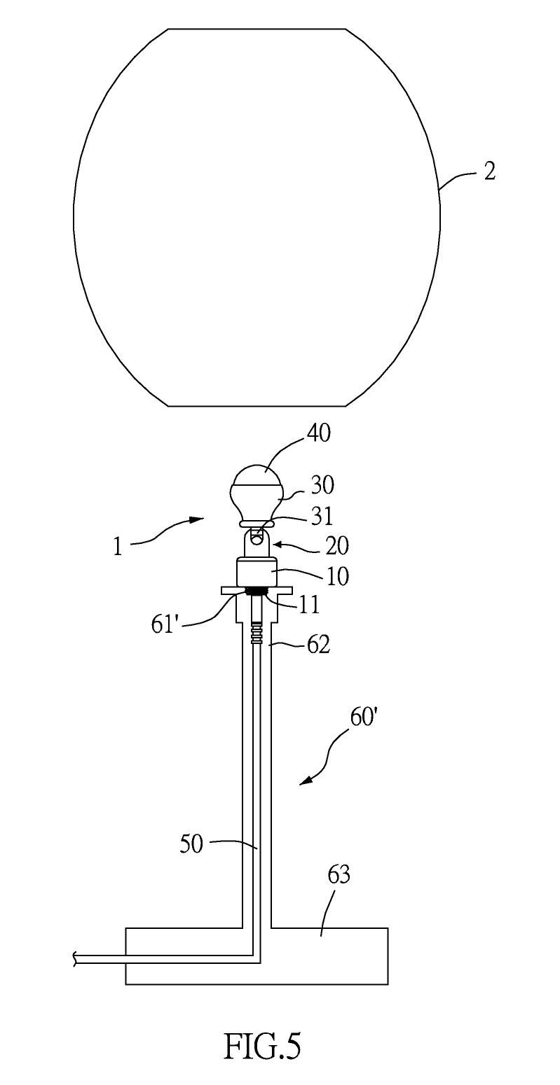

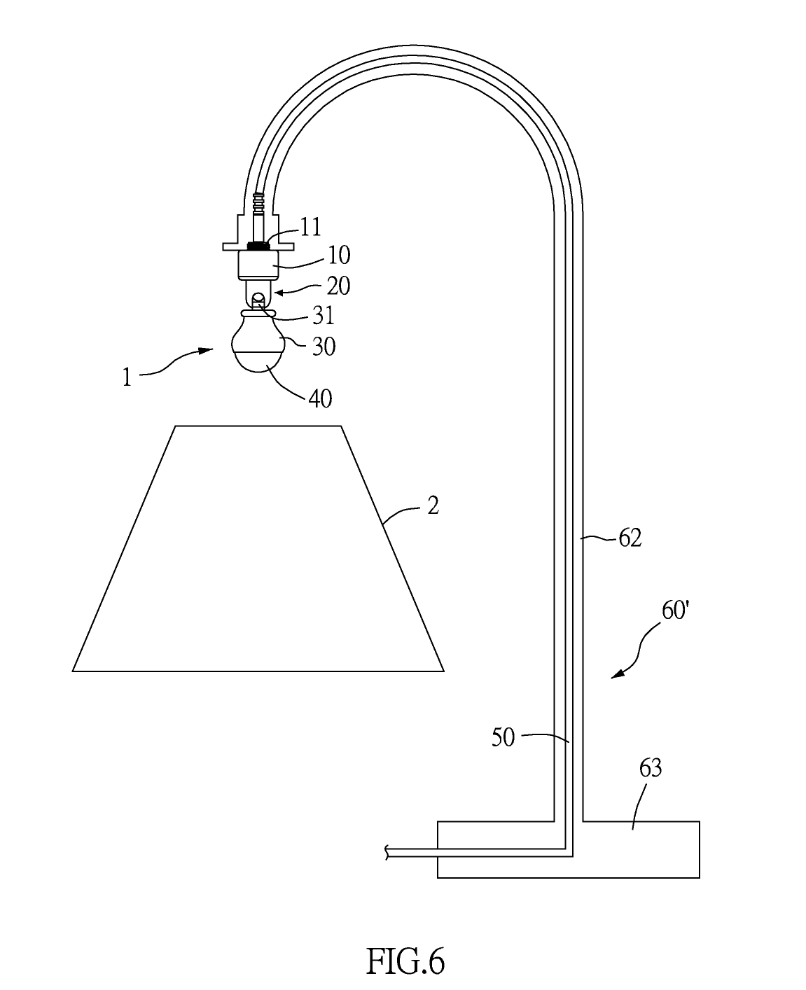

Referring to FIG. 5, there is shown a schematic view of a base 60′ according to an embodiment of the present invention. The base 60′ has a support 62 and a foundation 63. The support 62 is mounted or integrally formed on the foundation 63. The support 62 is penetrated by a wiring through hole which the power line 50 passes through. The adapter 10 of the light-emitting device 1 is disposed in a mounting hole 61′ of the base 60′ through the external thread of the post 11, so as to be coupled to the light bulb 2 to thereby form a vertical lamp or a bed lamp, for example. Referring to FIG. 6, in yet another embodiment of the present invention, the support 62 of the base 60′ is bent, such that the light-emitting device 1 emits light downward and thus is suitable for use in coupling with the light bulb 2 to thereby form a table lamp or a desk lamp, for example. The adapter 10 of the light-emitting device 1 is disposed in the mounting hole 61′ of the base 60′ not necessarily by the external thread of the post 11; instead, the post and the mounting hole are “bump and recess” engagement structures corresponding in position to each other. Alternatively, the DC connector at an end of the power line 50 is fixed to a stand of the light bulb 2, such that the light-emitting device 1 is coupled to the light bulb 2 as soon as the power line 50 is plugged into the jack 12 of the adapter 10.

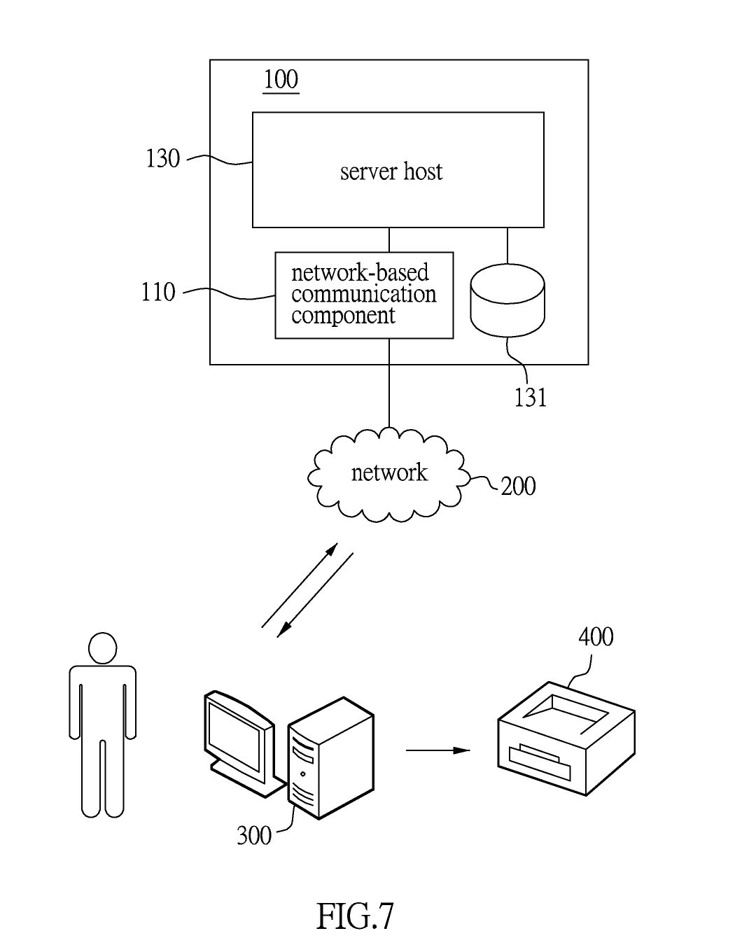

Referring to FIG. 7, there is shown a block diagram of a supply system on a 3D printing lamp line in an embodiment of the present invention. In this embodiment, a supply system 100 on the 3D printing lamp line is connected to an electronic device 300 of the user to thereby provide light bulb model files for use with the light-emitting device 1. The supply system 100 on the 3D printing lamp line comprises a network-based communication component 110 and a server host 130. The network-based communication component 110 is connected to a network 200. The server host 130 is connected to the network-based communication component 110 such that the electronic device 300 of the user gets connected to the server host 130 through the network 200. The server host 130 comprises a 3D model database 131. The 3D model database 131 stores the light bulb model files for use with a 3D printing device 400, such that the 3D printing device 400 prints the light bulb 2 according to the light bulb model files. The light bulb 2 is coupled to the light-emitting device 1 to thereby form the 3D printing lamp.

In this embodiment, the network-based communication component 110 is, for example, a network card or any other component connectable to the network 200. The network-based communication component 110 is connected to the network 200 to thereby connect with the electronic device 300 of the user. The network 200 comprises the Internet, a local area network (LAN) or a combination thereof. In addition, the network 200 includes any wired or wireless networks. In this embodiment, the electronic device 300 is an electronic apparatus connectable to the network 200, such as a desktop computer, smartphone, or tablet.

Therefore, the 3D model database 131 stores light bulb model files pertaining to various light bulb shapes, such that the user can download intended light bulb model files from the server host 130 by the electronic device 300 and through the network 200, and then print the light bulb 2 with the 3D printing device 400, wherein the light bulb 2 can be coupled to the light-emitting device 1 to thereby easily form the 3D printing lamp. Not only is the manufacturing of the light bulbs with different shapes easy and dispensed with transport, but the user can also easily and conveniently change the lamps of different shapes.

In conclusion, in an embodiment of the present invention, a light-emitting device of a 3D printing lamp can be conveniently mounted on a light bulb for use in 3D printing to thereby easily form a 3D printing lamp, and the light-emitting device rotatably adjusts the light emission angle and thus appropriately defines the shapes of the light bulb for use in 3D printing and patterns thereon, so as to meet user needs.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A light-emitting device of a 3D printing lamp, disposed in a light bulb for use in 3D printing, the light-emitting device comprising:
an adapter;
a connection unit disposed on the adapter and having a limiting opening;
a carrying unit having a connector to thereby be rotatably disposed in the limiting opening and having therein a receiving space for receiving at least a light-emitting diode module;
a transparent cover disposed on the carrying unit to hermetically seal the receiving space; and
a power line connected to the adapter.

2. The light-emitting device of claim 1, wherein the connection unit has a casing body, a limiting plate and a spring, wherein the casing body has an end provided with a limiting opening and another end connected to the adapter, wherein the limiting opening is provided with two limiting recesses opposing each other, wherein the connector has two curved bulging portions corresponding in position to the two limiting recesses, wherein the limiting plate has a surface in contact with the two curved bulging portions, wherein the spring is disposed in the casing body and compressed enough to abut against the limiting plate and the adapter.

3. The light-emitting device of claim 1, wherein the adapter has therein a terminal pluggable by the power line and connected to the light-emitting diode module through two wires, wherein a junction of each said wire and the terminal is enclosed by a heat-shrink tubing.

4. The light-emitting device of claim 2, wherein the adapter has therein a terminal pluggable by the power line and connected to the light-emitting diode module through two wires, wherein a junction of each said wire and the terminal is enclosed by a heat-shrink tubing.

5. The light-emitting device of claim 3, wherein the two wires are each enclosed by a wire sheath.

6. The light-emitting device of claim 4, wherein the two wires are each enclosed by a wire sheath.

7. The light-emitting device of claim 1, further comprising a base coupled to the adapter and adapted to underpin the light bulb.

8. The light-emitting device of claim 2, further comprising a base coupled to the adapter and adapted to underpin the light bulb.

9. The light-emitting device of claim 1, wherein a plug of the power line is a USB port.

10. The light-emitting device of claim 2, wherein a plug of the power line is a USB port.

11. The light-emitting device of claim 1, wherein the power line has a power switch for controlling the at least a light-emitting diode to turn on or turn off.

12. The light-emitting device of claim 2, wherein the power line has a power switch for controlling the at least a light-emitting diode to turn on or turn off.

13. A supply system on a 3D printing lamp line, connectable to an electronic device of a user, and applicable to light bulb model files of the light-emitting device of claim 1, comprising:
a network-based communication component connected to a network; and
a server host connected to the network-based communication component, such that the electronic device of the user gets connected to the server host through the network, wherein the server host comprises a 3D model database for storing light bulb model files for use with a 3D printing device to allow the 3D printing device to print a light bulb according to the light bulb model files, wherein the light bulb is coupled to the light-emitting device to form the 3D printing lamp.

14. A supply system on a 3D printing lamp line, connectable to an electronic device of a user, and applicable to light bulb model files of the light-emitting device of claim 2, comprising:
a network-based communication component connected to a network; and
a server host connected to the network-based communication component, such that the electronic device of the user gets connected to the server host through the network, wherein the server host comprises a 3D model database for storing light bulb model files for use with a 3D printing device to allow the 3D printing device to print a light bulb according to the light bulb model files, wherein the light bulb is coupled to the light-emitting device to form the 3D printing lamp.
